(19) United States
(12) Patent Application Publication
(10) Pub. No.: US 2012/0027959 A1
(43) Pub. Date: Feb. 2, 2012

(54) METHOD OF SHEATHING A SOLID-STATE LASER MEDIUM AND DEVICE FOR IMPLEMENTING IT

(76) Inventors: Alain Brenier, Toussieu (FR); Kheirreddine Lebbou, Villeurbanne (FR)

(21) Appl. No.: 13/143,985

(22) PCT Filed: Jan. 13, 2010
(86) PCT No.: PCT/FR2010/050046

§ 371 Date: Sep. 30, 2011

(30) Foreign Application Priority Data
Jan. 13, 2009 (FR) 0950152

(51) Int. Cl. B05D 5/00; H01S 3/063

(52) U.S. Cl. 427/596; 118/641

(57) ABSTRACT

The present invention relates to a method and to a device for sheathing a solid-state laser medium comprising an active solid-state core material coated with a sheath. According to the method of the invention: a) the core material, made in the form of an elongate bar along a fibre axis, is at least partially introduced into a capillary tube; b) a laser beam is focused onto an annular focusing zone of the capillary tube until said tube around the core material melts in said focusing zone but without melting said core material; and c) when the molten capillary material adheres to the core material, said core material and/or said capillary tube are moved in a direction collinear with the axis of the core.

The technical field of the invention relates to optical waveguides.

More particularly, the invention relates to the field of waveguides used in laser oscillators or amplifiers, comprising a solid core material doped with active centers making up the laser medium and at least one non-doped sheath surrounding this core material. In this document, the terms “laser fiber” and “sheathed solid-state laser medium” will be used equivalently and indifferently, without prejudice to the core and sheath diameter values.

Such laser fibers are used in solid lasers, benefitting in particular from longitudinal optical pumping with beams emitted by power laser diodes.

In the state of the art, it is known to make such laser waveguides by co-drawing a monocrystalline core and a glass sheath and using a laser-heated floating zone furnace. This is the LHPG (Laser Heated Pedestal Growth) method.

According to this method, a vertical source bar, formed by a core material inserted into a capillary tube, moves in an annular heating, so as to sweep the entire length thereof.

The heating is done using a laser beam, made annular by a set of conical reflectors arranged opposite each other followed by a planar mirror, then focused by a parabolic mirror over an annular focusing zone of the bar.

The melting of the capillary tube and the core material can be observed at the focusing zone. The capillary tube, in solidifying, adheres to the core material, which also solidifies, so as to form the sheath of the laser fiber.

Using this technique, the thickness of the deposited sheath depends on the thickness of the capillary tube. However, it is not possible to reliably monitor the thickness of the deposited sheath, or to vary this thickness during deposition.

Sometimes, depending on the nature of the core material and the power of the laser used for the melting of the glass, it happens that there is not only melting of the glass capillary and the core material, but also mixing of the glass and the core material. The performance of the resulting laser fiber is then generally inferior to the desired performance.

Documents US 2006/110122 and U.S. Pat. No. 3,656,925 also describe techniques for sheathing laser fibers using automated sheathing devices, but do not in particular allow precise and variable adjustment of the thickness of the sheath of the fiber on the sheathed laser medium.

One aim of the invention is therefore to propose a method for sheathing a solid-state laser medium, such as a laser fiber crystalline core, for example, making it possible to monitor the thickness of the deposited sheath.

Another aim of the invention is to propose a device allowing fast and easy sheathing of a solid-state laser medium while reliably monitoring the thickness of the sheath.

To that end, the present invention proposes a method for sheathing a solid-state laser medium having an active solid core material coated with a sheath and according to which:
a) the core material, made in the form of an elongate bar along an axis, is at least partially introduced into a capillary tube;
b) a laser beam is focused onto an annular focusing zone of the capillary tube until said tube around the core material melts in said focusing zone but without melting said core material; and
c) when the molten capillary material adheres to the core material, said core material and/or said capillary tube are moved in a direction collinear with the axis of the core and at different speeds.

The inventive method is therefore particularly advantageous in that it makes it possible, through relative movement of the core material and the capillary, to monitor the thickness of the sheath formed from the laser-molten capillary. This monitoring results in particular according to the invention from control and adjustment of the relative movement speeds of the core material and the capillary. By thus monitoring the formed sheath thickness and its variation, it is therefore possible to produce a sheathed solid-state laser medium such as a laser fiber capable of absorbing, in the core thereof, a constant pump power per unit of length over the entire length thereof, and therefore to improve the laser effect obtained from this fiber by homogenously distributing the heat production generated during the laser's operation over the entire length of the core.

According to a first preferred feature of the inventive method, during step c) the core material is kept at a temperature below its melting temperature.

According to another preferred feature of the invention, during step c) the focus of the laser beam is kept on an annular zone situated on the molten material at the end of the capillary tube.

According to the inventive method, the thickness of the sheath deposited on the core material is advantageously monitored by adjusting the movement speeds of the core material and the capillary tube so that the diameter d_{cl} of the sheath is such that:

$${d}_{cl} = \sqrt{{d}_{co}^{2} + \frac{{v}_{T}}{{v}_{co}} ( {d}_{e}^{2} - {d}_{i}^{2} )}$$

d_{co} being the diameter of the core, v_{T} being the movement speed of the tube, v_{co} being the movement speed of the core, dₑ being the outer diameter of the tube, and dᵢ being the inner diameter of the tube. Advantageously, adjusting the movements speeds of the core and the capillary intended to form the sheath procures a desired sheath thickness.

Still according to the invention and one particular embodiment of the proposed method, the movement speeds of the core material and the capillary tube are made to vary so as to vary the thickness of the sheath deposited on the core material.

This variation of the movement speeds of the core material and the capillary tube can be of two types.

First, the movement speed v_{T}(z) of the capillary tube is made to vary as a function of the length z of the movement of the core material, following the expression:

$${v}_{T} ( z ) = {v}_{T} ( 0 ) \pm {σ}_{ap} {N}_{{v}_{co}} \frac{{d}_{co}^{2}}{{d}_{e}^{2} - {d}_{i}^{2}} z$$

d_{co} being the diameter of the core,
dₑ being the outer diameter of the tube,
dᵢ being the inner diameter of the tube,
σₐₚ being the effective absorption section of the laser pump,
N being the concentration of the active centers of the laser medium,
v_{co} being the constant movement speed of the core material,
so as to vary the thickness of the sheath deposited on the core material so that the diameter d_{cl}(z) of the sheath is a function of the movement length z of the core material such that:

$${d}_{cl} ( z ) = \sqrt{{d}_{co}^{2} + \frac{{v}_{T} ( z )}{{v}_{co}} ( {d}_{e}^{2} - {d}_{i}^{2} )}$$

Second, the movement speed v_{co}(z) of the core material is made to vary as a function of the movement length z of this core material, following the expression:

$${v}_{co} ( z ) = \frac{1}{\frac{1}{{v}_{co} ( 0 )} \pm {σ}_{ap} N \frac{1}{{v}_{T}} \frac{{d}_{co}^{2}}{{d}_{e}^{2} - {d}_{i}^{2}} z}$$

d_{co} being the diameter of the core,
dₑ being the outer diameter of the tube,
dᵢ being the inner diameter of the tube,
σₐₚ being the effective absorption section of the laser pump,
N being the concentration of the active centers of the laser medium,
v_{T} being the movement speed of the capillary tube kept constant so as to vary the thickness of the sheath deposited on the core material so that the diameter d_{cl}(z) of the sheath is a function of the movement length z of the core material such that:

$${d}_{cl} ( z ) = \sqrt{{d}_{co}^{2} + \frac{{v}_{T}}{{v}_{co} ( z )} ( {d}_{e}^{2} - {d}_{i}^{2} )}$$

Furthermore, the inventive method can include at least one of the following additional features:
the relative horizontal movement of the core material and the capillary tube are monitored during step a),
the core material and the capillary tube each extend and are moved relative to each other along two non-coaxial collinear axes so as to obtain a solid-state laser medium whereof the core is off-center relative to the sheath,
the symmetry of revolution of the annular molten zone around the axis of the capillary is monitored,
the power of the melting laser of the capillary is monitored,
the temperature distribution near the heated zone is monitored,
the capillary is melted and the sheath is deposited in a confinement enclosure in a controlled atmosphere.

Another aim of the invention is to propose a device for sheathing a solid-state laser medium having an active solid-state core material coated with a sheath making it possible to monitor the thickness of the sheath.

According to the invention, this sheathing device has a first movement system on which the core material is fastened, said core material being made in the form of an elongate bar along an axis and said first movement system being able at least to move in a direction collinear to the core axis, a second movement system on which a capillary tube is fastened, the core material being at least partially inserted into the capillary tube and said second movement system at least being able to move in a direction collinear to the fiber axis. The inventive device also has a system for adjusting the movements of the first and second movement systems to different speeds to monitor the deposited sheath thickness, as well as an optical system adapted to focus a laser beam on an annular zone for annular focusing of the sheath, so as to melt the capillary tube around the core material, at said focusing zone and without melting said core material.

According to a first feature of the inventive device, the latter has a cooling system that keeps the core material at a temperature below its melting temperature.

Still according to the invention, the optical system keeps the focus of the laser beam on an annular zone situated on the molten material at the end of the capillary tube.

According to one preferred alternative embodiment, the adjustment system adjusts the movement speeds of the first and second movement systems according to the inventive method previously described.

According to one advantageous alternative embodiment, the first movement system and/or the second movement system is (are) adapted to measure the movements and monitor the movement speeds of the core material and the capillary tube.

Moreover, the sheathing device according to the invention can have at least one of the following features:
the first movement system and the second movement system is (are) adapted to move the core material and the capillary tube along two non-coaxial collinear axes so as to obtain a solid-state laser material whereof the core is off-center relative to the sheath,
the optical system has a CO₂-type laser emitting a laser beam, and at least one optical device adapted to orient and annularly focus the laser beam on the annular focusing zone of the sheath, the optical orientation and focusing device of the laser beam has a parabolic mirror able to be oriented along two axes of rotation that are perpendicular to each other, intersecting each other at the apex of the mirror, and perpendicular to the axis of the mirror,
the device has a system for monitoring the power of the laser beam,
the device has a system for visualizing the temperature distribution near the heated zone,
the device has a controlled atmosphere confinement enclosure.

Various other features will emerge from the description below in reference to the appended drawings, which show, as non-limiting examples, embodiments of the object of the invention.

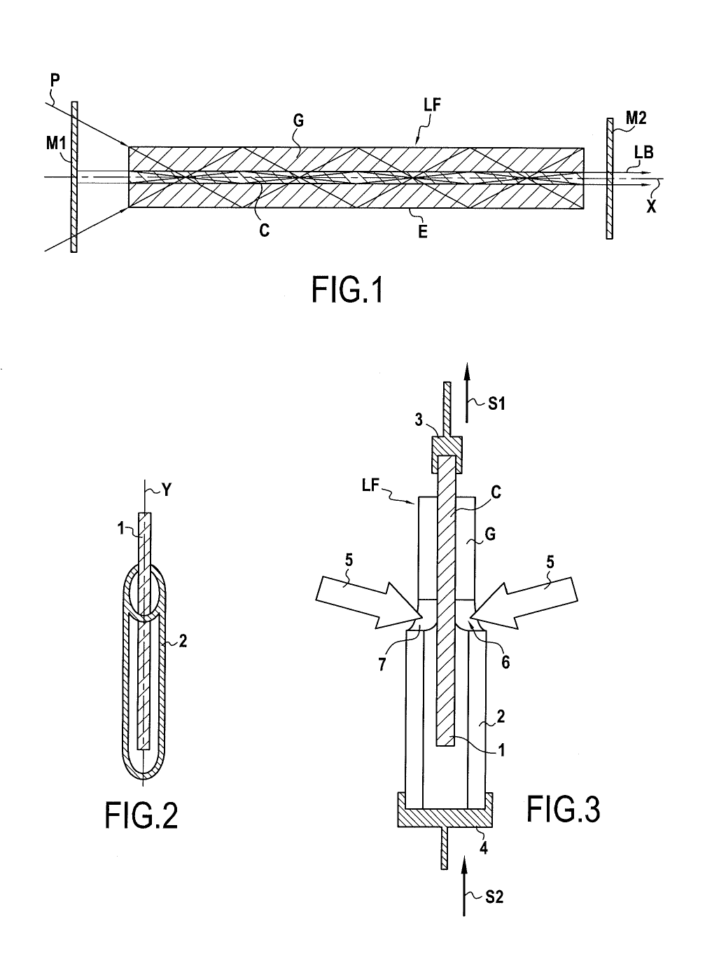

FIG. 1 diagrammatically illustrates a laser cavity in which the laser medium is formed by a laser fiber LF comprising an active solid core C and a sheath G obtained using the inventive method;

FIG. 2 shows the preparation step of the inventive method;

FIG. 3 shows a device according to the invention using the inventive method to deposit a sheath on a solid core material;

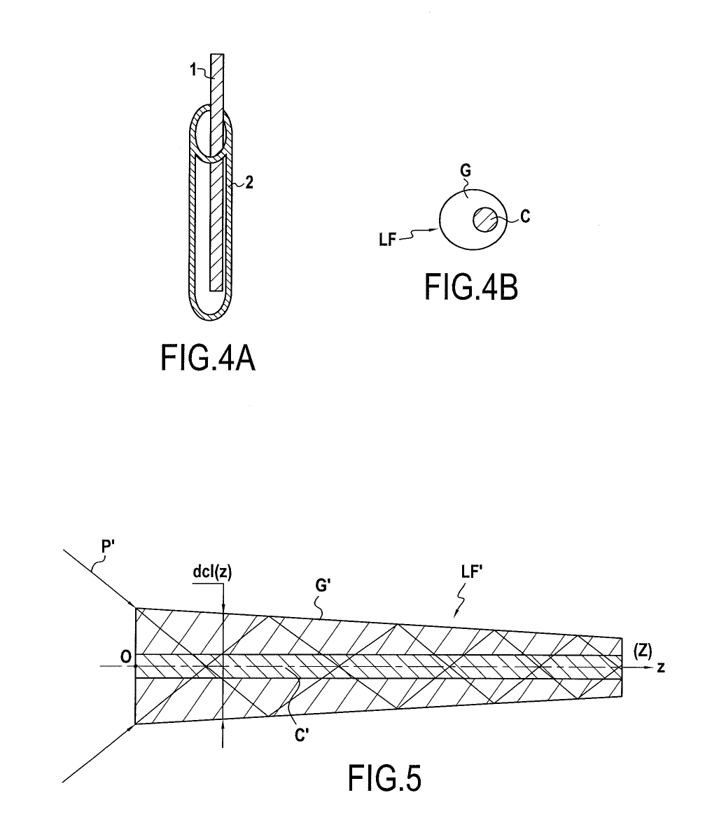

FIG. 4A shows an alternative of the preparation step of FIG. 2;

FIG. 4B is a transverse cross-sectional view of a laser fiber obtained by using the alternative shown in FIG. 4A;

FIG. 5 is a figure similar to FIG. 1, showing a laser fiber whereof the sheath has a variable thickness over the entire length thereof.

FIG. 1 diagrammatically shows a laser cavity designed to equip a fiber laser, and comprising a sheathed active solid-state laser medium obtained using the inventive method.

Of course, it is clear that a sheathed solid-state laser medium obtained using the inventive method can be integrated into any type of laser cavity, and that the inventive method is not limited to this type of application.

The operation of a fiber laser, known in itself, will not be described in detail below.

According to the illustrated embodiment, said laser cavity has a first dichroic mirror M1 arranged opposite a second, partially reflective mirror M2. Each mirror is planar or concave and its axis coincides with the cavity axis (X).

The solid-state laser medium, arranged between the first mirror M1 and the second mirror M2, is made in the form of a laser fiber LF extending along the cavity axis (X).

The laser fiber LF has an active solid-state core C coated with a sheath G provided with an outer wall E. The active solid-state core C is pumped by a pump beam P that spreads along the cavity axis (X), so as to emit an output laser beam LB that also spreads along the cavity axis (X). The pump beam P is for example emitted by at least one power laser diode (not shown).

The sheath G advantageously makes it possible to guide the pump beam P over the entire length of the laser fiber LF, for example by total reflection along the outer wall E, so as to at least partially distribute the absorption of the pump beam P by the active solid core C over the entire length of the laser fiber LF.

The present invention proposes a device and a method for sheathing a solid-state laser medium making it possible to reliably control the formation and deposition of the sheath on a solid-state laser medium such as a crystalline laser fiber core as described below in reference to FIGS. 2 and 3.

The sheathing device makes it possible to produce a laser fiber LF from a bar of a core material 1 extending along an axis at least partially inserted into a capillary tube 2.

The core material 1 makes up the active solid core C of the laser fiber LF and the capillary tube 2 allows it to produce the sheath G by melting its material. The core material 1 can for example be formed by a doped monocrystalline bar, a doped ceramic bar, or a doped glass bar. The capillary tube 2 can also be made in the form of a tube from vitreous, crystalline, metal or metal alloy, or non-doped organic material.

It is advisable for the core materials and the capillary tube to have close linear heat expansion coefficients (K⁻¹). One example of materials is Schott SF57 glass for the capillary tube and doped YAG crystal for the core. In the case of a core and a sheath that are both crystalline, it is also preferable for the crystalline array parameters of the core and the sheath to be adjusted to be very close. One example of materials for such an embodiment is a doped YAG core and a pure YAG capillary tube.

The sheathing device according to the invention has, as shown in FIG. 3, a first movement system 3, on which the core material 1 is fastened, and a second movement system 4 on which the capillary tube 2 is fastened.

The first movement system 3 is configured to move, in this case to draw, the core material 1 in a first direction S1 following a vertical direction parallel to the axis (Y). The second movement system 4 is adapted to move, in this case to push, the capillary tube 2 in a second direction S2 identical to the first direction 51 in which the core bar 1 is drawn by the first movement system 3. The first movement system 3 and the second movement system 4 both have motor means allowing movement of the core bar 1 and the capillary tube 2 in directions S1, S2, respectively, at different speeds.

The two movement systems 3, 4 also preferably have means for measuring and monitoring the movement distance of the core material 1 and the capillary tube 1 and/or for monitoring their movement speed.

The sheathing device according to the invention also has an optical system (not shown) adapted to emit a laser beam 5, shown by two solid arrows in FIG. 3, over an annular focusing zone 6 preferably situated at one end of the capillary tube 2.

According to one preferred embodiment of the inventive device, the optical system comprises a CO₂ laser emitting the laser beam 5 made annular by a set of conical reflectors arranged opposite each other and followed by a planar reflector, then focused by a parabolic mirror that can be oriented on the annular focusing zone 6. The set of conical reflectors and the series of mirrors make up an optical device that is not shown in the figures but is well known by those skilled in the art in the field of LHPG techniques, for example. This optical device has a parabolic mirror. According to the present invention, this parabolic mirror cooperates with a device for orienting said mirror around two perpendicular axes of rotation intersecting at the apex of said mirror and both perpendicular to the axis of the mirror. Such a device for orienting the parabolic mirror facilitates the obtainment of the revolution symmetry of the annular molten zone after interlocking of the core material in the tube from which the sheathing is done.

The optical system of the inventive device is adapted to initiate and maintain controlled melting of the capillary tube 2 at the focusing zone 6, around the core material 1 and without melting said core material 1 so as not to alter the structure of the active solid core C of the laser fiber LF obtained.

To that end, the sheathing device can have a system for monitoring the power of the laser beam 5 so as to monitor the degree of melting of the capillary tube 2 or, in one alternative that is not shown, a cooling system adapted to keep the core material 1 at a temperature below its melting temperature.

So as also to prevent accidental melting of the core material 1, it is also preferable to choose a core material 1 whereof the melting temperature is substantially higher than the melting temperature of the capillary tube 2. Moreover, the temperature distribution is also measured during the melting near the heated zone using a thermographic camera.

Lastly, the sheathing device also comprises, to avoid physico-chemical disruptions during sheathing of a solid-state laser medium such as a bar of a laser fiber core material 1, a controlled atmosphere confinement enclosure inside which the sheathing operations are performed, according to the sheathing method proposed by the present invention, which makes it possible to monitor the thickness of the sheath deposited on a solid-state laser medium such as a core bar 1 of a laser fiber and described below.

According to this method, in a first step a) a bar of a core material 1 is at least partially inserted into a capillary tube 2 as shown in FIG. 2. To that end, on one hand the core material 1 is fastened on the first movement system 3 of the sheathing device 3, and on the other hand the capillary tube 2 is fastened on the second movement system 4 of said device, then the driving means of both movements systems 3, 4 are activated so as to move the latter relative to each other and adjust the relative position of the core material 1 inside the capillary tube 2.

Then, in a second step b), the optical system of the device is used to focus laser beam 5 on an annular focusing zone 6 of the capillary tube 2 until said capillary tube 2 is melted around the core material 1.

The molten portion of the capillary tube 2, called molten capillary material 7 in the rest of this description, then adheres to the core material 1, for example under the effect of capillarity and gravitational forces.

Preferably, the annular focusing zone 6 is situated at one end of the capillary tube 2 and determines the level of the interface between the non-molten capillary tube 2 and the molten capillary material 7.

During this second step b) for focusing the laser beam 5 on the annular focusing zone 6 on the capillary tube 2, it is necessary to avoid any melting of the core material 1. To that end, if necessary dedicated cooling means of the sheathing device are actuated, even if the melting temperature of the treated core material 1 is higher than that of the capillary tube 2. Likewise, the power of the laser 5 is monitored at all times using fitting monitoring means of the sheathing device, assisted by thermographic imaging if necessary.

Once melted, the molten capillary material 7 adheres to the core material 1. The driving means of the movement systems 3, 4 of the inventive device are actuated so as to move, in a third step c), the core material 1 and/or the capillary tube 2 relative to each other in the directions S1, S2 previously defined and as shown by two arrows in FIG. 3.

In the example shown in FIG. 3, the movement direction of the core material 1 by the movement system 3 and that of the movement of the capillary tube 2 by the movement system 4 are both vertical and identical, just as the movement directions S1, S2 are identical. However, it is entirely possible, if necessary, and as will be described later, to perform the movement of the core material 1 and the capillary tube 2 in two distinct directions collinear with each other.

The movement of the core material 1 along S1 drives a drawing of the molten material 7, which causes it to solidify in contact with the core material 1 and causes the formation of a sheath G around it.

During the method, the focus of the laser beam 5 is kept on the annular focusing zone 6 so as to maintain the melting of the capillary tube and allows the gradual and continuous deposition of the sheath G on the core material 1 during the relative movements of said core material 1 and the capillary tube 2 by the movement systems 3, 4 of the device.

The inventive method as described above has the advantage of allowing the deposition of a sheath G on a solid-state laser medium such as the core material 1 continuously while perfectly monitoring the diameter d_{cl} of the sheath G deposited on the core material 1.

In fact, the inventive method makes it possible, by adjusting the movement speeds of the core material 1 and/or the capillary tube 2 via the movement system 3, 4, to choose and monitor the diameter d_{cl}. of the deposited sheath G.

In reference again to FIGS. 2 and 3, the core material 1 is made in the form of a bar with diameter d_{co}, the capillary tube 2 being made in the form of a hollow tube with inner diameter dᵢ, outer diameter dₑ. Considering that during the third step for depositing the sheath G on the core material 1, the latter is moved at a core speed called v_{co} while the capillary tube 2 is moved at a different tube speed v_{T}, and preferably slower than the core speed v_{co}, the inventors have experimentally demonstrated, when the stationary state of the molten zone is reached, that the thickness d_{cl} of the sheath G deposited on the core material 1 varies according to the following relationship:

$${d}_{cl} = \sqrt{{d}_{co}^{2} + \frac{{v}_{T}}{{v}_{co}} ( {d}_{e}^{2} - {d}_{i}^{2} )}$$

It is therefore possible, via the inventive sheathing method, to choose the diameter of the sheath G deposited on a solid-state laser medium and to control this diameter and therefore the thickness of the sheath G by adjusting and monitoring, in better compliance with the preceding equation, through suitable parameterization of the movement systems 3, 4 of the inventive device, and more particularly the driving means thereof, the movement speeds v_{co} and v of the core material 1 and the capillary tube 2.

In one alternative embodiment of the inventive method previously mentioned and shown in FIGS. 4A and 4B, it is possible, while keeping the mastery of the deposited sheath diameter on a solid-state laser medium, to produce an off-center sheathing of such a said solid-state laser medium, i.e. a sheathing in which the sheath is not symmetrical around the solid-state laser medium or the solid-state laser medium not centered in its sheath.

In reference to FIGS. 4A and 4B, it is then appropriate to perform such sheathing to position, during the first step of the inventive method, the core material 1 out of alignment inside the capillary tube 2, then, during the second and third steps, to move said core material 1 and the capillary tube 2 along two collinear and non-coaxial vertical axes.

This positioning is obtained by adapting the first movement system 3 and/or the second movement system 4 so as to move the core material 1 along a horizontal component relative to the capillary tube 2.

As shown in FIG. 4B, this alternative embodiment of the inventive method makes it possible to obtain a laser fiber LF whereof the active solid core C is off-centered relative to the sheath G.

It is also possible, according to the inventive sheathing method and in one particular embodiment thereof, to vary the movement speeds of the core material 1 and/or the capillary tube 2 during the sheathing, and more particularly during the third step c), so as to vary the thickness of the sheath d_{cl} all along the sheathed solid-state laser medium, for example a laser fiber LF′ as shown in FIG. 5.

The sheath G′ of said LF′ has a variable diameter d_{cl} over its entire length. The active solid-state core C′ of the laser fiber LF′ has an effective absorption section of the laser pump σₐₚ and a concentration N of the active centers of the laser medium.

In this embodiment, the active solid core C′ of the fiber is made in the form of a bar of a core material with diameter d_{co} extending along an axis (Z), the capillary tube to be melted to make the sheath G′ of the fiber LF′ being made in the form of a hollow tube with inner diameter dᵢ, with outer diameter dₑ and also extending along the same axis (Z). The core material is moved during step c) of the sheathing method at a core speed v_{co} while the capillary tube 2 is moved at a different tube speed v_{T} from the core speed v_{co}.

According to a first alternative of this particular embodiment, the movement speed v_{T}(z) of the capillary tube is made to vary as a function of the movement length z of the core material, according to the following expression:

$${v}_{T} ( z ) = {v}_{T} ( 0 ) \pm {σ}_{ap} {N}_{{v}_{co}} \frac{{d}_{co}^{2}}{{d}_{e}^{2} - {d}_{i}^{2}} z$$

so as to vary the thickness d_{cl} of the sheath G′ deposited on the core material so that the diameter d_{cl} of the sheath is a function of the movement length z of the core material such that:

$${d}_{cl} ( z ) = \sqrt{{d}_{co}^{2} + \frac{{v}_{T} ( z )}{{v}_{co}} ( {d}_{e}^{2} - {d}_{i}^{2} )}$$

In a second alternative of this particular embodiment, the movement speed v_{co}(z) of the core material is made to vary as a function of the movement length z of the core material, according to the expression:

$${v}_{co} ( z ) = \frac{1}{\frac{1}{{v}_{co} ( 0 )} \pm {σ}_{ap} N \frac{1}{{v}_{T}} \frac{{d}_{co}^{2}}{{d}_{e}^{2} - {d}_{i}^{2}} z}$$

so as to vary the thickness d_{cl} of the sheath G′ deposited on the core material so that the diameter d_{cl} of the sheath depends on the movement length z of the core material such that:

$${d}_{cl} ( z ) = \sqrt{{d}_{co}^{2} + \frac{{v}_{T}}{{v}_{co} ( z )} ( {d}_{e}^{2} - {d}_{i}^{2} )}$$

These two alternatives advantageously make it possible to obtain a sheathed solid-state laser medium such as a laser fiber LF′ whereof the absorption per unit of length

$$\frac{d {P}^{′}}{d z}$$

of the pump beam power P′ is constant over its entire length z, i.e. it does not depend on the movement length z.

1- A method for sheathing a solid-state laser medium having an active solid core material coated with a sheath and according to which:
a) the core material, made in the form of an elongate bar along an axis, is at least partially introduced into a capillary tube,
b) a laser beam is focused onto an annular focusing zone of the capillary tube until said tube around the core material melts in said focusing zone but without melting said core material, and
c) when the molten capillary material adheres to the core material, said core material and/or said capillary tube are moved in a direction collinear with the axis of the core and at different speeds.

2- The method for sheathing a solid-state laser medium according to claim 21, wherein during step c) the core material is kept at a temperature below its melting temperature.

3- The method for sheathing a solid-state laser medium according to claim 1, wherein during step c) the focus of the laser beam is kept on an annular zone situated on the molten material at the end of the capillary tube.

4- The method for sheathing a solid-state laser medium according to claim 1, wherein the thickness of the sheath deposited on the core material is advantageously monitored by adjusting the movement speeds of the core material and the capillary tube so that the diameter d_{cl} of the sheath is such that:
$${d}_{cl} = \sqrt{{d}_{co}^{2} + \frac{{v}_{T}}{{v}_{co}} ( {d}_{e}^{2} - {d}_{i}^{2} )}$$
d_{co} being the diameter of the core,
v_{T} being the movement speed of the tube,
v_{co} being the movement speed of the core,
dₑ being the outer diameter of the tube,
dᵢ being the inner diameter of the tube.

5- The method for sheathing a solid-state laser medium according to claim 4, wherein the movement speeds of the core material and the capillary tube are made to vary so as to vary the thickness of the sheath deposited on the core material.

6- The method for sheathing a solid-state laser medium according to claim 5, wherein the movement speed v_{T}(z) of the capillary tube is made to vary as a function of the length z of the movement of the core material, according to the expression:
$${v}_{T} ( z ) = {v}_{T} ( 0 ) \pm {σ}_{ap} {N}_{{v}_{co}} \frac{{d}_{co}^{2}}{{d}_{e}^{2} - {d}_{i}^{2}} z$$
d_{co} being the diameter of the core,
dₑ being the outer diameter of the tube,
dᵢ being the inner diameter of the tube,
σₐₚ being the effective absorption section of the laser pump, N being the concentration of the active centers of the laser medium,
v_{co} being the constant movement speed of the core material,
so as to vary the thickness of the sheath deposited on the core material so that the diameter d_{cl}(z) of the sheath is a function of the movement length z of the core material such that:
$${d}_{cl} ( z ) = \sqrt{{d}_{co}^{2} + \frac{{v}_{T} ( z )}{{v}_{co}} ( {d}_{e}^{2} - {d}_{i}^{2} )}$$

7- The method for sheathing a solid-state laser medium according to claim 5, wherein the movement speed v_{co}(z) of the core material is made to vary as a function of the movement length z of this core material, according to the expression:
$${v}_{co} ( z ) = \frac{1}{\frac{1}{{v}_{co} ( 0 )} \pm {σ}_{ap} N \frac{1}{{v}_{T}} \frac{{d}_{co}^{2}}{{d}_{e}^{2} - {d}_{i}^{2}} z}$$
d_{co} being the diameter of the core,
dₑ being the outer diameter of the tube,
dᵢ being the inner diameter of the tube,
σₐₚ being the effective absorption section of the laser pump,
N being the concentration of the active centers of the laser medium,
v_{T} being the movement speed of the capillary tube kept constant so as to vary the thickness of the sheath deposited on the core material so that the diameter d_{cl}(z) of the sheath is a function of the movement length z of the core material such that:
$${d}_{cl} ( z ) = \sqrt{{d}_{co}^{2} + \frac{{v}_{T}}{{v}_{co} ( z )} ( {d}_{e}^{2} - {d}_{i}^{2} )}$$

8- The method for sheathing a solid-state laser medium according to claim 1, wherein the relative horizontal movement of the core material and the capillary tube are monitored during step c).

9- The method for sheathing a solid-state laser medium according to claim 1, wherein the core material and the capillary tube each extend and are moved relative to each other along two non-coaxial collinear axes so as to obtain a solid-state laser medium whereof the core is off-center relative to the sheath.

10- The method for sheathing a solid-state laser medium according to claim 1, wherein the power of the melting laser of the capillary is monitored.

11- The method for sheathing a solid-state laser medium according to claim 1, wherein the capillary is melted and the sheath is deposited in a confinement enclosure in a controlled atmosphere.

12- A device for sheathing a solid-state laser medium having an active solid-state core material coated with a sheath, characterized in that it has:
a first movement system on which the core material is fastened, said core material being made in the form of an elongate bar along an axis and said first movement system being able at least to move in a direction collinear to the core axis,
a second movement system on which a capillary tube is fastened, the core material being at least partially inserted into the capillary tube and said second movement system at least being able to move in a direction collinear to the fiber axis,
a system for adjusting the movements of the first and second movement systems to different speeds to monitor the deposited sheath thickness,
an optical system adapted to focus a laser beam on an annular zone for annular focusing of the sheath, so as to melt the capillary tube around the core material, at said focusing zone and without melting said core material.

13- The device for sheathing a solid-state laser medium according to claim 12, characterized in that it has a cooling system that keeps the core material at a temperature below its melting temperature.

14- The device for sheathing a solid-state laser medium according to claim 12, characterized in that the optical system keeps the focus of the laser beam on an annular zone situated on the molten material at the end of the capillary tube.

15- A device for sheathing a solid-state laser medium having an active solid-state core material coated with a sheath, characterized in that it has:
a first movement system on which the core material is fastened, said core material being made in the form of an elongate bar along an axis and said first movement system being able at least to move in a direction collinear to the core axis,
a second movement system on which a capillary tube is fastened, the core material being at least partially inserted into the capillary tube and said second movement system at least being able to move in a direction collinear to the fiber axis,
a system for adjusting the movements of the first and second movement systems to different speeds to monitor the deposited sheath thickness,
an optical system adapted to focus a laser beam on an annular zone for annular focusing of the sheath, so as to melt the capillary tube around the core material, at said focusing zone and without melting said core material, characterized in that said adjustment system adjusts the movement speeds of the first and second movement systems according to claim 4.

16- The device for sheathing a solid-state laser medium according to claim 12, characterized in that the first movement system and/or the second movement system is (are) adapted to measure the movements and monitor the movement speeds of the core material and the capillary tube.

17- The device for sheathing a solid-state laser medium according to claim 12, characterized in that the first movement system and the second movement system is (are) adapted to move the core material and the capillary tube along two non-coaxial collinear axes so as to obtain a solid-state laser material whereof the core is off-center relative to the sheath.

18- The device for sheathing a solid-state laser medium according to claim 12, characterized in that the optical system has a parabolic mirror that cooperates with a device for orienting said mirror around two perpendicular axes of rotation intersecting at the apex of the mirror and both perpendicular to the axis of the mirror.

19- The device for sheathing a solid-state laser medium according to claim 12, characterized in that the optical system has a CO₂-type laser emitting a laser beam, and at least one optical device adapted to orient and annularly focus the laser beam on the annular focusing zone of the sheath.

20- The device for sheathing a solid-state laser medium according to claim 12, characterized in that it has a system for monitoring the power of the laser beam.

21- The device for sheathing a solid-state laser medium according to claim 12, characterized in that it has a controlled atmosphere confinement enclosure.
